(19) United States
(12) Patent Application Publication
(10) Pub. No.: US 2023/0123872 A1
(43) Pub. Date: Apr. 20, 2023

(54) METHOD FOR DETECTION OF ANOMOLOUS OPERATION OF A SYSTEM

(71) Applicant: Siemens Energy, Inc., Orlando, FL (US)

(72) Inventors: Bruno Paes Leao, Princeton, NJ (US); Leandro Pfleger de Aguiar, Leander, TX (US); Matheus Martins, Plainsboro Township, NJ (US); Matthew Stewart, Commerce Township, MI (US)

(21) Appl. No.: 17/906,196

(22) PCT Filed: Mar. 19, 2021
(86) PCT No.: PCT/US2021/023172

§ 371 Date: Sep. 13, 2022

Related U.S. Application Data
(60) Provisional application No. 62/992,247, filed on Mar. 20, 2020.

(51) Int. Cl. G06F 21/55; G06F 21/62

(52) U.S. Cl. CPC G06F 21/554; G06F 21/6218; G06F 2221/033

(57) ABSTRACT

A computer-implemented method of detecting an anomalous action associated with a physical system includes developing, by a computing device a plurality of vectors, each vector indicative of an event that occurred at a specific time within the system, combining, with the computing device each vector that occurred within a predefined time duration into one of a plurality of master vectors, and performing, with the computing device a cluster analysis to group each master vector of the plurality of master vectors into one of a plurality of states. The method also includes determining, with the computing device a real-time master vector based at least in part on one or more events that occur within the predefined time duration, classifying, with the computing device the real-time master vector as a real-time state, and indicating that the real-time state is anomalous when the real-time state doesn't match one of the plurality of states.

### BACKGROUND

There are many anomaly detection solutions applied to industrial systems and processes. However in general they apply either to the network communication realm or to the process data realm, which makes each system limited in terms of what it can detect and especially in what it can diagnose (e.g. differentiating security issues from failures). One representative example is the NIST report NISTIR 8219 (National Institute of Standards and Technology Report Titled “Securing Manufacturing Industrial Control Systems: Behavioral Anomaly Detection”) where three behavioral anomaly detection solutions applied to industrial control system are presented. Two of them are focused on network communication and the other is based on process data.

### SUMMARY

In one aspect, a computer-implemented method of detecting with a computer system an anomalous action associated with a physical system includes developing, by a computing device a plurality of vectors, each vector of the plurality of vectors indicative of an event that occurred at a specific time within the system, combining, with the computing device each vector that occurred within a predefined time duration into one of a plurality of master vectors, and performing, with the computing device a cluster analysis to group each master vector of the plurality of master vectors into one of a plurality of states. The method also includes determining, with the computing device a real-time master vector based at least in part on one or more events that occur within the predefined time duration, classifying, with the computing device the real-time master vector as a real-time state, and indicating that the real-time state is anomalous when the real-time state does not match one of the plurality of states.

In another aspect, a computer-implemented method of detecting with an engine control system an anomalous action associated with an engine includes developing, by a computing device a plurality of vectors, each vector of the plurality of vectors indicative of one of an operating condition, a status, an alarm condition, network data, and process data that occurred at a specific time within the engine, combining, with the computing device each vector that occurred within a predefined time duration into one of a plurality of master vectors, and performing, with the computing device a cluster analysis to group each master vector of the plurality of master vectors into one of a plurality of states. The method also includes determining, using the computing device a real-time master vector based at least in part on one or more events that occur within the predefined time duration, comparing, using the computing device the real-time master vector to the plurality of master vectors, classifying, using the computing device the real-time master vector as a real-time state, and indicating that the real-time state is anomalous when the real-time state does not match one of the plurality of states.

In another aspect, a computing apparatus includes a processor. The computing apparatus also includes a memory storing instructions that, when executed by the processor, configure the apparatus to develop a plurality of vectors, each vector of the plurality of vectors indicative of an event that occurred at a specific time within the system, combine each vector that occurred within a predefined time duration into one of a plurality of master vectors, and perform a cluster analysis to group each master vector of the plurality of master vectors into one of a plurality of states. The apparatus also operates to associate an associated user action with each state of the plurality of states, determine a real-time master vector based at least in part on one or more events that occur within the predefined time duration, classify the real-time master vector as a real-time state which is selected from the plurality of states, compare a real-time user action to the associated user action that is associated with the real-time state, and indicate that an anomalous user action has occurred when the real-time user action does not match the associated user action.

### BRIEF DESCRIPTION OF THE DRAWINGS

To easily identify the discussion of any particular element or act, the most significant digit or digits in a reference number refer to the figure number in which that element is first introduced.

FIG. 1 illustrates a functional block diagram of an example computer system that facilitates operation of an anomaly detection system.

FIG. 2 illustrates a block diagram of a data processing system in which the anomaly detection system may be implemented.

FIG. 3 is a flow chart illustrating a portion of the anomaly detection system.

FIG. 4 is a three-dimensional graph of a plurality of master vectors showing the clustering of those master vectors into states.

FIG. 5 is a flow chart illustrating the operation of a model training pipeline suitable for use in training a classifier for the anomaly detection system.

FIG. 6 is a flow chart illustrating the anomaly detection system.

FIG. 7 is a flow chart illustrating the operation of the anomaly detection system of FIG. 6.

### DETAILED DESCRIPTION

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Further the phrase “at least one” before an element (e.g., a processor) that is configured to carry out more than one function/process may correspond to one or more elements (e.g., processors) that each carry out the functions/processes and may also correspond to two or more of the elements (e.g., processors) that respectively carry out different ones of the one or more different functions/processes

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise.

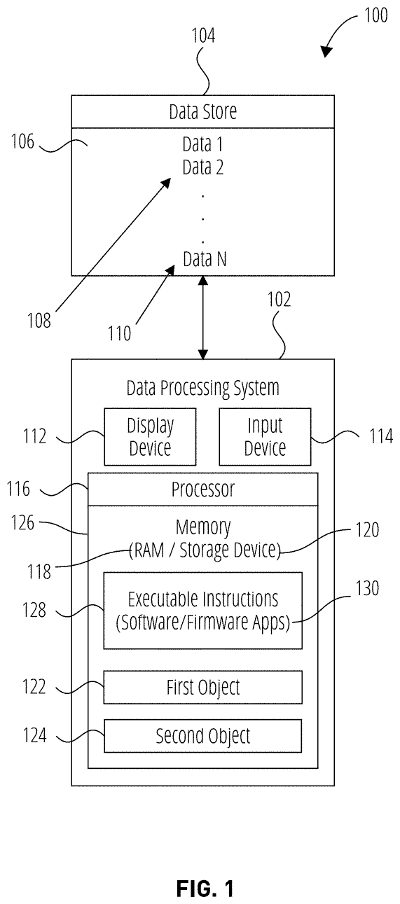

With reference to FIG. 1, an example system 100 is described that enables operation of the anomaly detection system 300, 600 described herein. The system 100 employs at least one data processing system 102. A data processing system may comprise at least one processor 116 (e.g., a microprocessor/CPU). The processor 116 may be configured to carry out various processes and functions described herein by executing from a memory 126, computer/processor executable instructions 128 corresponding to one or more applications 130 (e.g., software and/or firmware) or portions thereof that are programmed to cause the at least one processor to carry out the various processes and functions described herein.

Such a memory 126 may correspond to an internal or external volatile or nonvolatile processor memory 118 (e.g., main memory, RAM, and/or CPU cache), that is included in the processor and/or in operative connection with the processor. Such a memory may also correspond to non-transitory nonvolatile storage device 120 (e.g., flash drive, SSD, hard drive, ROM, EPROMs, optical discs/drives, or other non-transitory computer readable media) in operative connection with the processor.

The described data processing system 102 may optionally include at least one display device 112 and at least one input device 114 in operative connection with the processor 116. The display device, for example, may include an LCD or AMOLED display screen, monitor, VR headset, projector, or any other type of display device capable of displaying outputs from the processor. The input device, for example, may include a mouse, keyboard, touch screen, touch pad, trackball, buttons, keypad, game controller, gamepad, camera, microphone, motion sensing devices that capture motion gestures, or other type of input device capable of providing user inputs or other information to the processor.

The data processing system 102 may be configured to execute one or more applications 130 that facilitates the features described herein. Such an application, for example, may correspond to a component included as part of the anomaly detection system 300, 600 described below.

For example, as illustrated in FIG. 1, the at least one processor 116 may be configured via executable instructions 128 (e.g., included in the one or more applications 130) included in at least one memory or data store 104 to operate the anomaly detection system 300, 600, a graphical user interface (GUI), or other programs, systems, or software.

While the methodology is described as being a series of acts that are performed in a sequence, it is to be understood that the methodology may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

It should be appreciated that this described methodology may include additional acts and/or alternative acts corresponding to the features described previously with respect to the data processing system 100.

It is also important to note that while the disclosure includes a description in the context of a fully functional system and/or a series of acts, those skilled in the art will appreciate that at least portions of the mechanism of the present disclosure and/or described acts may be capable of being distributed in the form of computer/processor executable instructions 128 (e.g., software/firmware applications 130) contained within a storage device 120 that corresponds to a non-transitory machine-usable, computer-usable, or computer-readable medium in any of a variety of forms. The computer/processor executable instructions 128 may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, Julia, C, C#, C++ or any other form of code that can be programmed/configured to cause at least one processor to carry out the acts and features described herein. Still further, results of the described/claimed processes or functions may be stored in a computer-readable medium, displayed on a display device, and/or the like.

It should be appreciated that acts associated with the above-described methodologies, features, and functions (other than any described manual acts) may be carried out by one or more data processing systems 102 via operation of one or more of the processors 116. Thus, it is to be understood that when referring to a data processing system, such a system may be implemented across several data processing systems organized in a distributed system in communication with each other directly or via a network.

As used herein a processor corresponds to any electronic device that is configured via hardware circuits, software, and/or firmware to process data. For example, processors described herein may correspond to one or more (or a combination) of a microprocessor, CPU, GPU or any other integrated circuit (IC) or other type of circuit that is capable of processing data in a data processing system 102. As discussed previously, the processor 116 that is described or claimed as being configured to carry out a particular described/claimed process or function may correspond to a CPU that executes computer/processor executable instructions 128 stored in a memory 126 in the form of software to carry out such a described/claimed process or function. However, it should also be appreciated that such a processor may correspond to an IC that is hardwired with processing circuitry (e.g., an FPGA or ASIC IC) to carry out such a described/claimed process or function. Also, it should be understood, that reference to a processor may include multiple physical processors or cores that are configured to carry out the functions described herein. In addition, it should be appreciated that a data processing system and/or a processor may correspond to a controller that is operative to control at least one operation.

In addition, it should also be understood that a processor that is described or claimed as being configured to carry out a particular described/claimed process or function may correspond to the combination of the processor 116 with the executable instructions 128 (e.g., software/firmware applications 130) loaded/installed into the described memory 126 (volatile and/or non-volatile), which are currently being executed and/or are available to be executed by the processor to cause the processor to carry out the described/claimed process or function. Thus, a processor that is powered off or is executing other software, but has the described software loaded/stored in a storage device 120 in operative connection therewith (such as on a hard drive or SSD) in a manner that is available to be executed by the processor (when started by a user, hardware and/or other software), may also correspond to the described/claimed processor that is configured to carry out the particular processes and functions described/claimed herein.

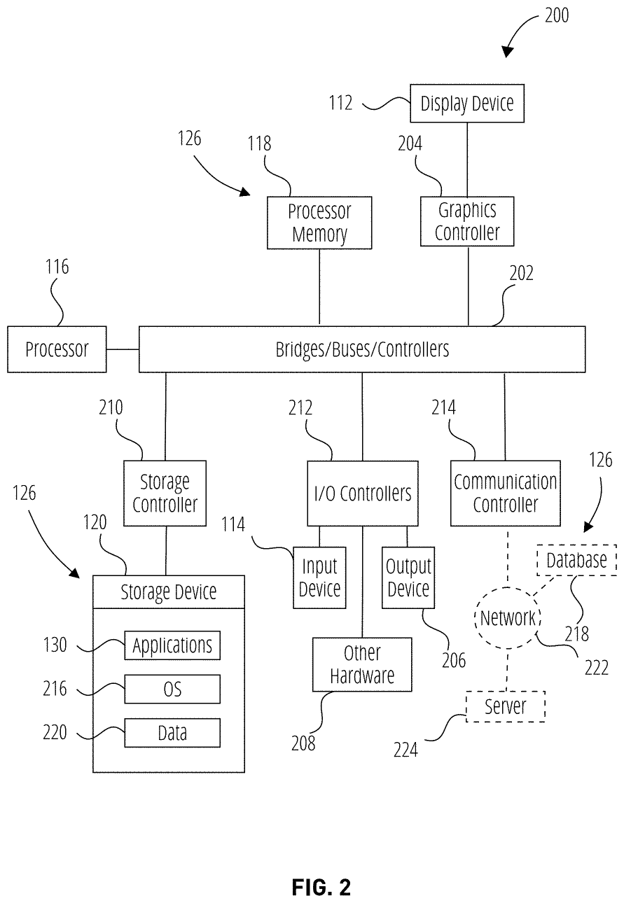

FIG. 2 illustrates a further example of a data processing system 200 with which one or more embodiments of the data processing system 102 described herein may be implemented. For example, in some embodiments, the at least one processor 116 (e.g., a CPU/GPU) may be connected to one or more bridges/buses/controllers 202 (e.g., a north bridge, a south bridge). One of the buses for example, may include one or more I/O buses such as a PCI Express bus. Also connected to various buses in the depicted example may include the processor memory 118 (e.g., RAM) and a graphics controller 204. The graphics controller 204 may generate a video signal that drives the display device 112. It should also be noted that the processor 116 in the form of a CPU/GPU or other processor may include a memory therein such as a CPU cache memory. Further, in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controller 214 (Ethernet controllers, WiFi controllers, cellular controllers) operative to connect to a network 222 such as a local area network (LAN), Wide Area Network (WAN), the Internet, a cellular network, and/or any other wired or wireless networks or communication equipment. The data processing system 200 may be operative to communicate with one or more servers 224, and/or any other type of device or other data processing system, that is connected to the network 210. For example, in some embodiments, the data processing system 200 may be operative to communicate with a memory 126. Examples of a database may include a relational database (e.g., Oracle, Microsoft SQL Server). Also, it should be appreciated that is some embodiments, such a database may be executed by the processor 116.

Further components connected to various busses may include one or more I/O controllers 212 such as USB controllers, Bluetooth controllers, and/or dedicated audio controllers (connected to speakers and/or microphones). It should also be appreciated that various peripherals may be connected to the I/O controller(s) (via various ports and connections) including the input device 114, and an output device 206 (e.g., printers, speakers) or any other type of device that is operative to provide inputs to and/or receive outputs from the data processing system.

Also, it should be appreciated that many devices referred to as input devices or output devices may both provide inputs and receive outputs of communications with the data processing system 200. For example, the processor 116 may be integrated into a housing (such as a tablet) that includes a touch screen that serves as both an input and display device. Further, it should be appreciated that some input devices (such as a laptop) may include a plurality of different types of input devices (e.g., touch screen, touch pad, and keyboard). Also, it should be appreciated that other hardware 208 connected to the I/O controllers 212 may include any type of device, machine, sensor, or component that is configured to communicate with a data processing system.

Additional components connected to various busses may include one or more storage controllers 210 (e.g., SATA). A storage controller 210 may be connected to a storage device 120 such as one or more storage drives and/or any associated removable media. Also, in some examples, a storage device 120 such as an NVMe M.2 SSD may be connected directly to a bus 202 such as a PCI Express bus.

It should be understood that the data processing system 200 may directly or over the network 222 be connected with one or more other data processing systems such as a server 224 (which may in combination correspond to a larger data processing system). For example, a larger data processing system may correspond to a plurality of smaller data processing systems implemented as part of a distributed system in which processors associated with several smaller data processing systems may be in communication by way of one or more network connections and may collectively perform tasks described as being performed by a single larger data processing system.

A data processing system in accordance with an embodiment of the present disclosure may include an operating system 216. Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, macOS, and Android operating systems.

As used herein, the processor memory 118, storage device 120, and memory 126 may all correspond to the previously described memory 126. Also, the previously described applications 130, operating system 216, and data 220 may be stored in one more of these memories or any other type of memory or data store. Thus, the processor 116 may be configured to manage, retrieve, generate, use, revise, and/or store applications 130, data 220 and/or other information described herein from/in the processor memory 118, storage device 120 and/or memory 126.

In addition, it should be appreciated that data processing systems may include virtual machines in a virtual machine architecture or cloud environment that execute the executable instructions. For example, the processor and associated components may correspond to the combination of one or more virtual machine processors of a virtual machine operating in one or more physical processors of a physical data processing system 200. Examples of virtual machine architectures include VMware ESCi, Microsoft Hyper-V, Xen, and KVM. Further, the described executable instructions 128 may be bundled as a container that is executable in a containerization environment such as Docker executed by the processor 116.

Also, it should be noted that the processor described herein may correspond to a remote processor located in a data processing system such as a server that is remote from the display and input devices described herein. In such an example, the described display device and input device may be included in a client data processing system (which may have its own processor) that communicates with the server (which includes the remote processor) through a wired or wireless network (which may include the Internet). In some embodiments, such a client data processing system, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In another example, such a client data processing system may execute a web browser or thin client application. Inputs from the user may be transmitted from the web browser or thin client application to be evaluated on the server, rendered by the server, and an image (or series of images) sent back to the client data processing system to be displayed by the web browser or thin client application. Also, in some examples, the remote processor described herein may correspond to a combination of a virtual processor of a virtual machine executing in a physical processor of the server.

Those of ordinary skill in the art will appreciate that the hardware and software depicted for the data processing system may vary for particular implementations. The depicted examples are provided for the purpose of explanation only and is not meant to imply architectural limitations with respect to the present disclosure. Also, those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system 200 may conform to any of the various current implementations and practices known in the art.

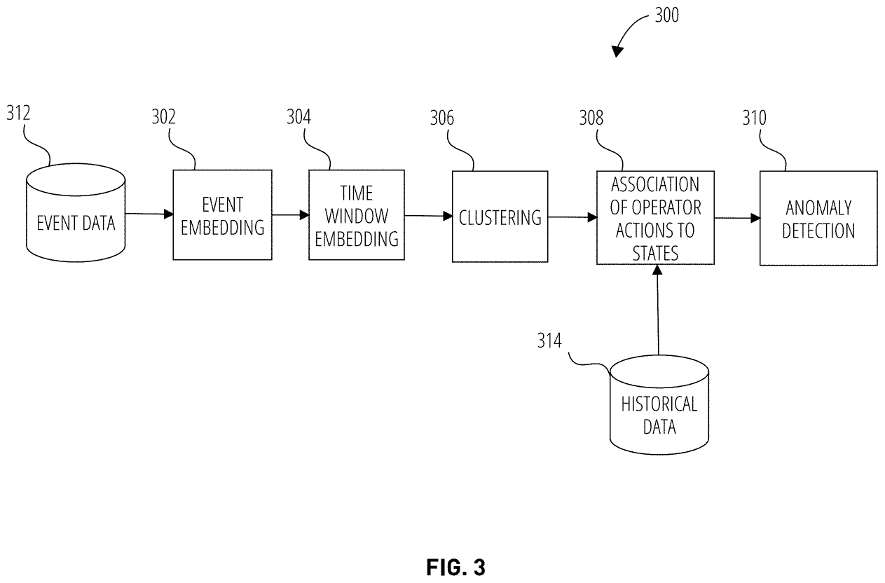

FIG. 3 through FIG. 6 illustrate a detection system 300 and method for the calculation of a discrete state representation of a process or system being monitored to determine if anomalous activity has occurred or is occurring. Systems could include a number of different industrial systems or engines such as turbogenerator systems and the like. In one application, the detection system 300 of FIG. 3 is implemented in a computer control system that operates a gas turbine engine that generates electrical power for distribution to an electrical grid or to another load. To aid in understanding, the remainder of this description will refer to this specific example of implementation of the detection system 300. However, it should be clear that the invention is not limited to this single application.

The detection system 300 is implemented using one or more computers or computer systems and is built or trained using a combination of different data sources. In some examples, historical log data or event data 312 which may include network data, process data, log data, operating condition data, status data, or alarm conditions is available. For many turbogenerator systems, event data 312 may be available for many years of operation.

The event data 312 is subjected to a process of event embedding 302 such as those which originate from the Natural Language Processing (NLP) domain for transforming words into numerical vectors of a defined length. These NLP methods apply to event data 312 such as log and computer network data. In addition, these NLP can be applied to process data if combined with some discretization method such as symbolic aggregate approximation (SAX). Alternatively, dimensionality reduction methods such as Autoencoders can be applied to transform time series sample data into a numerical vector of defined length. Therefore, the description of FIG. 3 will be based on event data for simplification without loss of generality.

FIG. 3 illustrates the basic data processing pipeline associated with the method and detection system 300. Event embedding 302 can employ a number of embedding methods, such as Word2vec, to associate a numerical vector of a pre-defined length to each entity of interest. In the NLP domain, entities correspond to words and in the application described here, entities correspond to events or event data 312. The vectors are defined in such a way that the distance between them is indicative of the similarity between the entities. The closer the vectors, the greater the similarity. Similarity in this case corresponds to the frequent occurrence in similar contexts, where the entity context is in turn defined by a set of other entities that occur in its vicinity. Cosine distance is usually employed for measuring the distance between vectors. Results of event embedding 302 obtained for individual entities can also be combined to form embeddings for sets of entities. Those sets can correspond, for instance, to sentences in the NLP domain.

Once the event embedding 302 is complete, the results are analyzed to perform a process of time window embedding 304. The vectors from the event embedding 302 are grouped according to the time of their occurrence. Specifically, a fixed predefined time duration (e.g., five minutes or less, one minute or less, thirty seconds or less, ten seconds, etc.) is used to group the vectors. In other constructions, the predefined time duration can be fixed time windows. For example, a time window could be from 1:00 PM to 1:05 PM. Once the vectors are grouped by the predetermined time duration, they are combined into a plurality of master vectors with each master vector corresponding to the events in one of the predefined time duration windows. One process of time window embedding 304 or set embedding is to simply average the corresponding entity embeddings or vectors. Weighted averaging using, for instance, Term Frequency-Inverse Document Frequency (TF-IDF) may improve the results compared to standard averaging. However, other embedding methods employed in NLP (for embedding words or sentences directly) or other domains can be employed. For example, transformer deep neural network-based methods such as BERT could be employed.

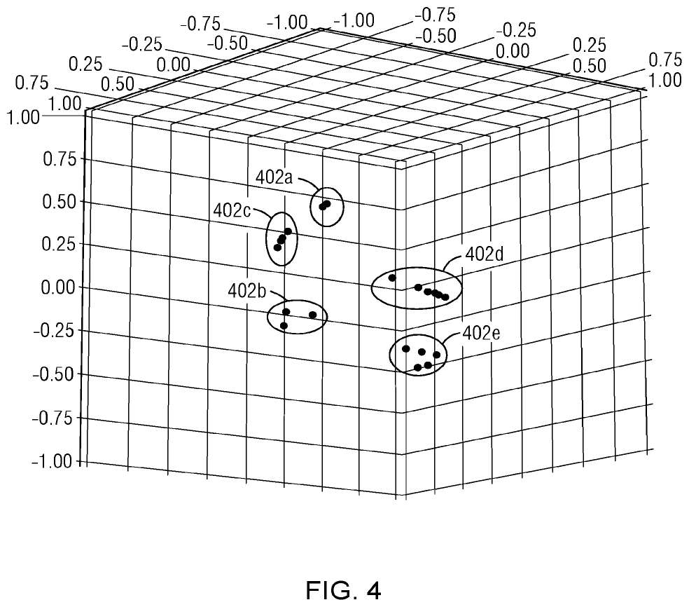

Once the process of time window embedding 304 is complete, a process of clustering 306 can be performed on the master vectors to form a discrete representation of the system state as illustrated in FIG. 4. The process of clustering 306 may employ standard clustering methods such as k-means and DBS CAN. Of course, other clustering methods could be employed if desired.

FIG. 4 illustrates sample results for clustering three-dimensional time window embeddings resulting in five distinct clusters 402a-402e or system states. Each of the points in FIG. 4 represents one of the master vectors graphed against three selected scales. Of course, many different parameters or values could be employed to establish the clusters 402a-402e or system states.

Returning to FIG. 3, after the completion of clustering 306 a discrete representation of the system state is available. Specifically, a plurality of states or clusters 402a-402e are established. At this point, an optional step of action association 308 can be performed. Historical data 314 can be used to associate operator or system actions to each state or cluster 402a-402e. The actions can include specific actions taken, the probability of one or more actions occurring at each state, or a combination thereof. In one example, it is possible that for a particular state or cluster 402a a first action has a first probability, a second action has a second probability, and a third action has a third probability of occurring.

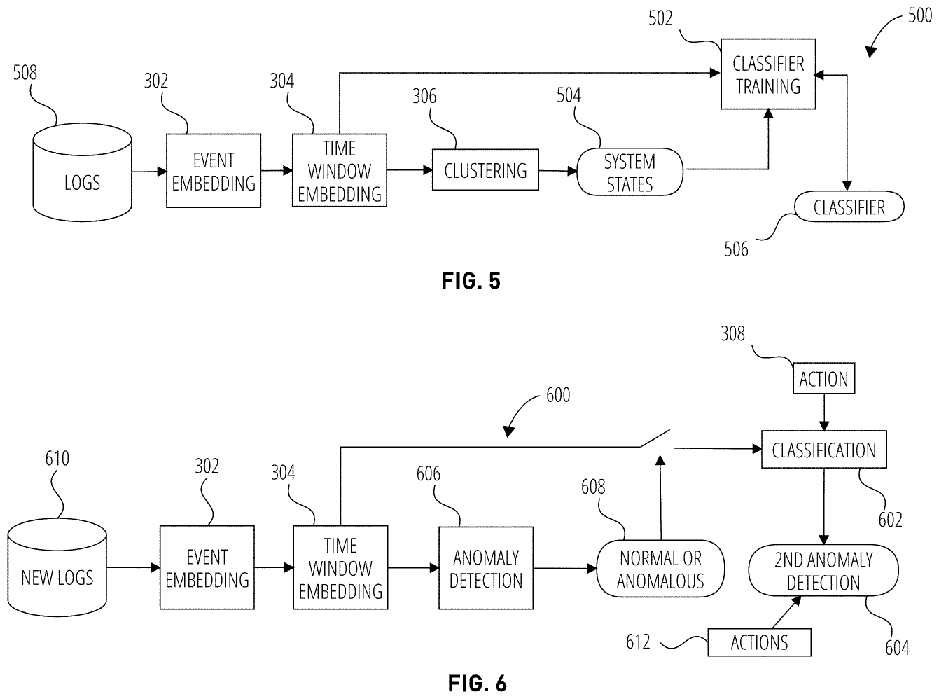

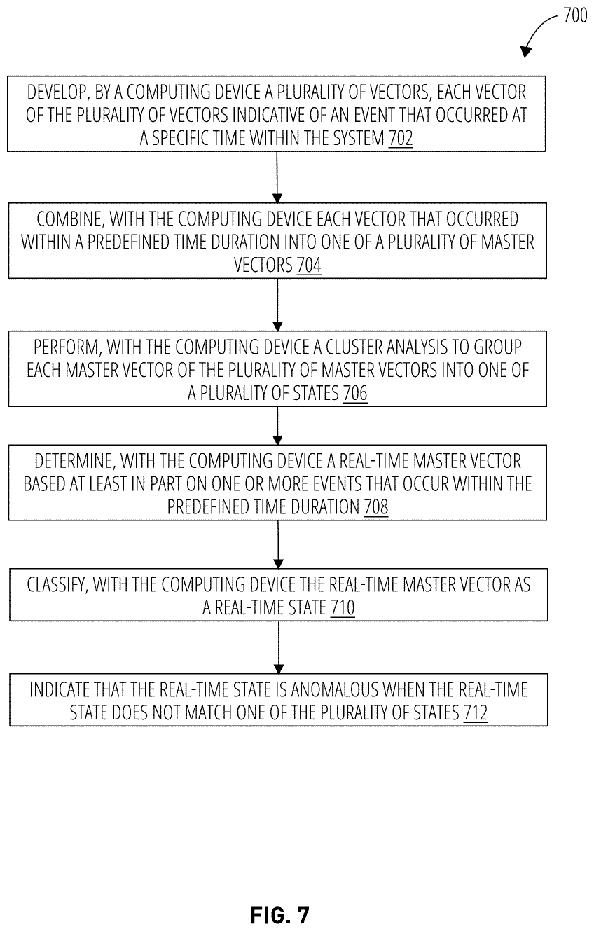

Once clustering 306 is complete and, in the cases where action association 308 is completed the detection system 300 can be employed to perform anomaly detection 310. As will be discussed in greater detail with regard to FIG. 5 and FIG. 6, anomaly detection 310 can be based solely on an analysis of the real-time or current state of the system or on a comparison of the real-time actions taken by a user compared to those associated with the states or clusters 402a-402e. In the case of anomaly detection 310 based on the real-time actions of the user, the anomaly detection 310 may be based on a probability threshold.

Before proceeding, it should be noted that the term “real-time” or “real-time data” is meant to refer to new data or recent data that is being analyzed. The data could be older data that is being presented for review. Thus, unanalyzed data from virtually any time period could be considered real-time data for purposes of this description.

FIG. 5 illustrates a model training pipeline 500 that can be used to train a classifier 506 that can then be used for anomaly detection 310. As illustrated in FIG. 5, logs 508 are used as event data 312. The logs 508 are simply historical data for the operation of the system (e.g., the turbogenerator system). The data in the logs 508 is provided for event embedding 302, time window embedding 304, and clustering 306 as described with regard to FIG. 3. The clustering 306 ultimately results in a number of system states 504 or a plurality of system states 504.

A portion of the data contained in the logs 508 can be reused as if it is real-time data in order to develop and test the classifier 506. If used for testing, the data is again provided for event embedding 302 and time window embedding 304 such that the data is converted to a plurality of master vectors.

Each of the master vectors and the system states 504 are provided for classifier training 502. During training and testing, the classifier 506 which can include machine learning or other AI-based techniques analyzes each master vector and assigns a predicted system state to that master vector. The assigned predicted system state can then be compared to the system state determined for that master vector through clustering 306 and the classifier 506 adjusted until they match. Using this process yields a classifier 506 that is capable of predicting the system state for a real-time master vector without performing a clustering analysis.

FIG. 6 illustrates a detection system 600 that could be used to detect anomalies in both system states and user actions. The detection system 600 receives real-time data from new logs 610 and that data is processed through event embedding 302 and time window embedding 304 to produce real-time master vectors for each time window in the real-time data.

The real-time master vectors are used in a state anomaly detection routine 606 to determine if the current or real-time state of the system is itself an anomaly. The state anomaly detection routine 606 utilizes the classifier 506 to assign a predicted state to each of the real-time master vectors generated by the time window embedding 304. The anomaly decision 608 then compares those states to the known operating states of the system and if there is no match, the predicted state is identified as anomalous. In other words, the detection system 600 includes anomaly detection based on the state representation itself. In other words, if the time window embedding is not close enough to any of the clusters identified during training, it is considered to be anomalous.

In some constructions, an optional second anomaly detection routine 604 is provided as part of the detection system 600. After the first anomaly decision 608, the second anomaly detection routine 604 can be initiated if the anomaly decision 608 indicated no anomaly or it could be initiated regardless of the results of the anomaly decision 608. In order to perform the second anomaly detection routine 604, the real-time master vectors are passed from the time window embedding 304 to a classification routine 602. The classification routine 602 includes the classifier 506 and classifies the real-time master vectors to determine predicted real-time states. Alternatively, the predicted real-time states can be passed from the state anomaly detection routine 606. In addition, the associated user or system actions for each state are passed from the action association 308 to the classification routine 602. This information is then used by the second anomaly detection routine 604 along with the actual or real-time actions 612 associated with the real-time master vector. A comparison is made between the real-time actions 612 and the associated user or system actions for the state in which the real-time master vector is classified. If the comparison shows that the actions do not match, the real-time actions are deemed anomalous. As discussed, the associated actions can be probabilities of two or more actions. In this case, a threshold value may be set to determine if the actions do not match.

In this case, the anomaly is not based on the time window of events itself being different from usual but on other information associated with the resulting discrete state. For example, each time the operator or user performs a certain action, the system is in a first state, if this same action is now performed when the system is in a second state, this can be considered an anomaly.

States as defined here can also be applied in alternative settings for anomaly detection. One way of doing this would be to model the transition between states, for instance in the form of a Markov chain, and use information associated with this transition, e.g. the transition probability in the case of a Markov chain, for detecting anomalies. In this case, a threshold could be defined such that transitions with probability lower than the threshold would be considered anomalies.

The detection system 600 can be used to detect both state anomalies, and user action anomalies in many different systems including the turbogenerator discussed with regard to FIG. 3. Continuing that example, the arrangement of FIG. 5 can use stored data logs 508 that include event data 312 as well as user or system action data associated with the event data 312. The data is used to train the classifier 506 for use in the detection system 600 of FIG. 6. While actual operating data is used for the training, other similar data, from similar engines for example, may be employed for training.

During operation of the turbogenerator, data is constantly collected and stored in the new logs 610. That data could be analyzed in real-time to detect anomalies or could be reviewed periodically after it is collected. The data is converted to real-time master vectors as has been described and is analyzed to determine if an anomalous state exists. For example, the turbogenerator could have a normal operation state, a base load state, a load following state, and the like. In addition, the control system, which houses the detection system 600 could have an on-line state, an offline state, and any number of other states. If these were the only states and the real-time master vectors did not fit into any of these states, the detection system 600 would identify that condition as an anomalous state.

In addition, the detection system 600 can determine which state the real-time master vectors fall under and can include associated user or system actions. These would be the actions normally taken by the system or an operator during operation in the particular state. As noted, the actions can be specific actions or can be probabilities of a particular action. In addition, multiple actions can be associated with a given state.

The new logs 610 contain the actual actions taken by the system and the user and these actual or real-time user and system actions can be compared to the associated user and system actions for the particular state. If the real-time user and system actions do not match the associated user and system actions (or fall within an acceptable limit), the detection system 600 can identify the action as an anomalous action.

The detection system 600 provides easy ways of combining multiple sources, possibly heterogeneous data sources into a standard representation which can comprehensively describe the state of the system or process of interest for proper evaluation of anomalies. This can potentially provide better performance in terms of greater detection rate and lower false alarm rates compared to existing solutions and provide information for better diagnosing the nature of anomalies.

In block 702, the anomaly detection routine 700 develops, by a computing device a plurality of vectors, each vector of the plurality of vectors indicative of an event that occurred at a specific time within the system. In block 704, the anomaly detection routine 700 combines, with the computing device each vector that occurred within a predefined time duration into one of a plurality of master vectors. In block 706, the anomaly detection routine 700 performs, with the computing device a cluster analysis to group each master vector of the plurality of master vectors into one of a plurality of states. In block 708, the anomaly detection routine 700 determines, with the computing device a real-time master vector based at least in part on one or more events that occur within the predefined time duration. In block 710, the anomaly detection routine 700 classifies, with the computing device the real-time master vector as a real-time state. In block 712, the anomaly detection routine 700 indicates that the real-time state is anomalous when the real-time state does not match one of the plurality of states.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A computer-implemented method of detecting with a computer system an anomalous user action associated with a physical system, the method comprising:
developing, by a computing device a plurality of vectors, each vector of the plurality of vectors indicative of an event that occurred at a specific time within the system;
combining, with the computing device each vector that occurred within a predefined time duration into one of a plurality of master vectors;
performing, with the computing device a cluster analysis to group each master vector of the plurality of master vectors into one of a plurality of states;
determining, with the computing device a real-time master vector based at least in part on one or more events that occur within the predefined time duration;
classifying, with the computing device the real-time master vector as a real-time state;
indicating that the real-time state is anomalous when the real-time state does not match one of the plurality of states.

2. The computer-implemented method of claim 1, wherein each event is one of an operating condition, a status, an alarm condition, network data, and process data.

3. The computer-implemented method of claim 1, further comprising converting data associated with an event to a vector using a natural language process.

4. The computer-implemented method of claim 1, further comprising using log data from prior system operation to develop the plurality of states.

5. The computer-implemented method of claim 1, wherein the predetermined predefined time duration is less than five minutes.

6. The computer-implemented method of claim 1, wherein the associated user actions include a probability of transitioning from one state to another state.

7. The computer-implemented method of claim 1, further comprising:
associating an associated user action with each state of the plurality of states;
comparing a real-time user action to the associated user action that is associated with the real-time state; and
indicating that an anomalous user action has occurred when the real-time user action does not match the associated user action.

8. The computer-implemented method of claim 7, wherein the associated user actions include probabilities of two different specific actions for at least one state.

9. A computer-implemented method of detecting with an engine control system an anomalous user action associated with an engine, the method comprising:
developing, by a computing device a plurality of vectors, each vector of the plurality of vectors indicative of one of an operating condition, a status, an alarm condition, network data, and process data that occurred at a specific time within the engine;
combining, with the computing device each vector that occurred within a predefined time duration into one of a plurality of master vectors;
performing, with the computing device a cluster analysis to group each master vector of the plurality of master vectors into one of a plurality of states;
determining, using the computing device a real-time master vector based at least in part on one or more events that occur within the predefined time duration;
classifying, using the computing device the real-time master vector as a real-time state; and
indicating that the real-time state is anomalous when the real-time state does not match one of the plurality of states.

10. The computer-implemented method of claim 9, wherein the engine is a turbogenerator operable to generate electrical power.

11. The computer-implemented method of claim 9, further comprising converting data associated with an event to a vector using a natural language process.

12. The computer-implemented method of claim 9, further comprising using log data from prior system operation to develop the plurality of states.

13. The computer-implemented method of claim 9, wherein the predetermined predefined time duration is less than one minute.

14. The computer-implemented method of claim 9, wherein the associated user actions include probabilities of two different specific actions for at least one state.

15. The computer-implemented method of claim 9, wherein the associated user actions include a probability of transitioning from one state to another state.

16. The computer-implemented method of claim 9, further comprising:
associating an associated user action with each state of the plurality of states;
comparing a real-time user action to the associated user action that is associated with the real-time state; and
indicating that an anomalous user action has occurred when the real-time user action does not match the associated user action.

17. A computing apparatus comprising:
a processor; and
a memory storing instructions that, when executed by the processor, configure the apparatus to:
develop a plurality of vectors, each vector of the plurality of vectors indicative of an event that occurred at a specific time within the system;
combine each vector that occurred within a predefined time duration into one of a plurality of master vectors;
perform a cluster analysis to group each master vector of the plurality of master vectors into one of a plurality of states;
associate an associated user action with each state of the plurality of states;
determine a real-time master vector based at least in part on one or more events that occur within the predefined time duration;
classify the real-time master vector as a real-time state which is selected from the plurality of states;
compare a real-time user action to the associated user action that is associated with the real-time state; and
indicate that an anomalous user action has occurred when the real-time user action does not match the associated user action.

18. The computing apparatus of claim 17, wherein each event is one of an operating condition, a status, an alarm condition, network data, and process data.

19. The computing apparatus of claim 17, wherein the instructions further configure the apparatus to convert data associated with an event to a vector using a natural language process.

20. The computing apparatus of claim 17, wherein the predetermined predefined time duration is less than thirty seconds.

21. The computing apparatus of claim 17, wherein the associated user actions include probabilities of two different specific actions for at least one state.

22. The computing apparatus of claim 17, wherein the associated user actions include a probability of transitioning from one state to another state.
